(19) United States
(12) Patent Application Publication
(10) Pub. No.: US 2010/0204979 A1
(43) Pub. Date: Aug. 12, 2010

(54) System and method for magnifiedly displaying real-time translated word

(75) Inventors: Chaucer Chiu, Taipei (TW); Feng Lin, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/320,849

(22) Filed: Feb. 6, 2009

(51) Int. Cl. G06F 17/28

(52) U.S. Cl. 704/3

(57) ABSTRACT

A system and a method for magnifiedly displaying a real-time translated word are provided, which include setting a display size of a retrieved word, displaying the retrieved word based on the display size, and displaying a corresponding translation data obtained through looking up, thereby solving the problem about an excessive large difference in font size between a word in an existing file and a corresponding translation data thereof from the real-time translation, and thus achieving a technical effect of magnifying the retrieved word. The retrieved word can be magnifiedly displayed in a floating window or in an original window.

### BACKGROUND OF THE INVENTION

1. Field of the Invention

The present invention relates to a system and a method for displaying real-time translation, and more particularly, to a system and a method for magnifiedly displaying a real-time translated word.

2. Related Art

In the coming digital times, more and more traditional services begin to provide the same services through networks and computers, for example, the goods transaction activity has switched to network shopping, and reading books and magazines has switched to reading corresponding electronic books, and so on.

Generally, when reading traditional books and magazines written in paper, a user needs to use a dictionary to look up an unfamiliar word to understand the meaning of an article if the language of the article is different from his/her own familiar language. Accordingly, the dictionary used by the user also changes from a paper dictionary to an electronic dictionary, which is more convenient. However, when reading an electronic book, if she/he needs to look up for an unfamiliar word, there is one way that is more convenient than using an electronic dictionary, that is, using real-time translation. The real-time translation can display a translation data for an unfamiliar word in a floating window when the user drags a cursor to the unfamiliar word, thereby enabling the user to know the meaning of the word.

However, in order to meet the requirements of typesetting, a digital file may adopt various font styles and font sizes, and the font in the file may be increasingly small, so as to enable the user to read richer contents. As such, since the font of the words in the floating window for displaying the translation data in the real-time translation function may be much greater than the font in the file, it is rather painful for the user to read the file due to the excessive large difference in font size when the user watches the word inquired and the translation data thereof.

To sum up, the problem about the excessive large difference in the font size between words in a file and a translation data from a real-time translation has existed in the prior art for a long time, thereby causing reading inconveniences for a user. Therefore, it is necessary to propose an improved technical solution to solve such a problem.

### SUMMARY OF THE INVENTION

In view of the problem in the prior art about an excessively large difference in the font size between a word in a file and a translation data thereof from a real-time translation, the present invention is directed to a system and a method for magnifiedly displaying a real-time translated word.

The system for magnifiedly displaying a real-time translated word according to the present invention includes: a detect module, adapted to detect a position of a cursor after the cursor is moved; a retrieve module, adapted to retrieve a word overlapping the cursor after the detect module has detected that the cursor is moved; a set module, adapted to set a scale parameter and a display size corresponding to the scale parameter; a word database, adapted to store the translation data for a word; a lookup module, adapted to look up the translation data from the word database; a display module, adapted to display a word in a first floating window based on the display size, and display a translation data in a second floating window. Therefore, the system of the present invention solves the problem in the prior art by setting the scale parameter corresponding to the display size by the set module, and displaying the word retrieved through the retrieve module based on the display size and the translation data looked up through the lookup module by the display module.

The method for magnifiedly displaying a real-time translated word according to the present invention includes the following steps: retrieving a word overlapping a cursor when detecting that the cursor is moved; looking up a translation data for the word in a word database; setting a scale parameter; displaying the word in a first floating window based on a display size corresponding to the scale parameter; and displaying the translation data in a second floating window. The method of the present invention solves the problem in the prior art by displaying the retrieved word based on a display size after setting the scale parameter corresponding to the display size and displaying the looked up translation data.

The system and the method of the present invention have been described above, the difference between the present invention and the prior art is that, the present invention can set a display size for a retrieved word, display the retrieved word based on the display size, and display a looked up translation data. With the previous technical means, the present invention can achieve a technical effect of magnifying the retrieved word.

### BRIEF DESCRIPTION OF THE DRAWINGS

The present invention will become more fully understood from the detailed description given herein below for illustration only, and thus are not limitative of the present invention, and wherein:

FIG. 1 is an architecture view of a system for magnifiedly displaying a real-time translated word according to the present invention.

FIG. 2 is a flow chart of a method for magnifiedly displaying a real-time translated word according to the present invention.

FIG. 3A is a schematic view of displaying a word and a translation data in different floating windows according to an embodiment of the present invention.

FIG. 3B is a schematic view of replacing a cursor with a floating window for displaying words according to an embodiment of the present invention.

FIG. 4A is a schematic view of a word when a cursor is moved on according to an embodiment of the present invention.

FIG. 4B is a schematic view of a font size of a word when the word is magnified according to an embodiment of the present invention.

### DETAILED DESCRIPTION OF THE INVENTION

Those Chinese characters shown in the following descriptions or in the drawings are just mentioned for describing the embodiments and are substantially irrelevant to any technical matters.

The detailed features and advantages of the present invention will be described in detail in the following embodiments. Those skilled in the arts can easily understand and implement the content of the present invention. Furthermore, the relative objectives and advantages of the present invention are apparent to those skilled in the arts with reference to the content disclosed in the specification, claims, and drawings.

Those Chinese characters shown in the following descriptions or in the drawings are just mentioned for describing the embodiments and are substantially irrelevant to any technical matters.

The present invention is applied to an operating system in which a graphical user interface (GUI) is executed (simply called “graphical interface operating system”), and the GUI refers to a computer operating environment which displays an application in a graphical way.

A picture displayed when the GUI is started is generally called “desktop”, on which windows produced by a plurality of applications are displayed. A user can operate the applications in the corresponding windows produced by the applications, for example, managing, generating, and editing data, etc.

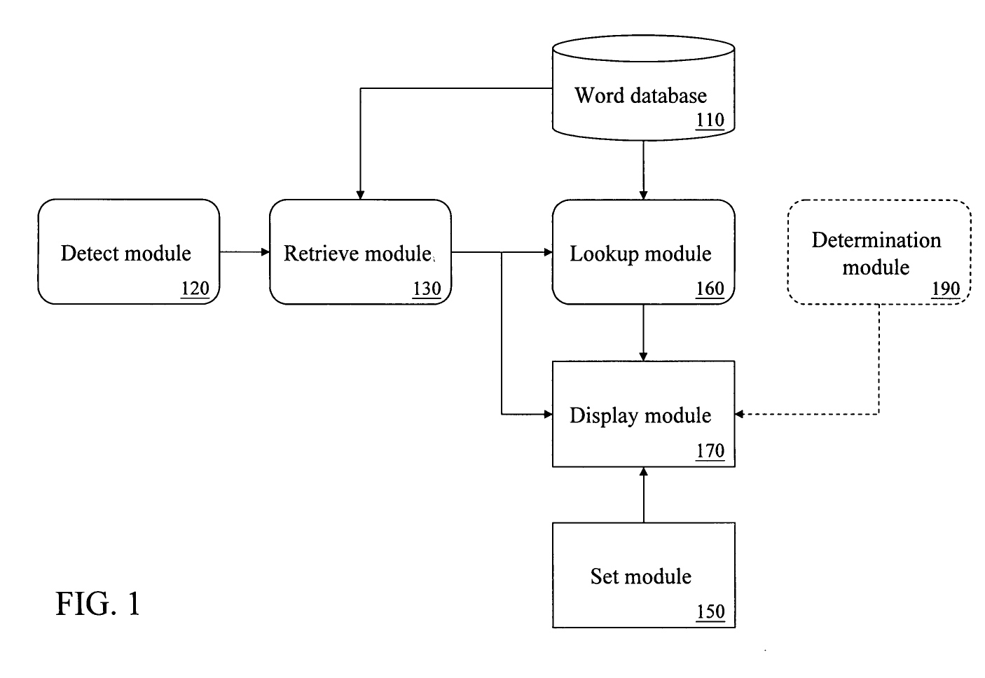

First, the operations of the system according to the present invention are illustrated below with reference to FIG. 1. FIG. 1 is an architecture view of a system for magnifiedly displaying a real-time translated word according to the present invention. As shown in FIG. 1, the system of the present invention includes a word database 110, a detect module 120, a retrieve module 130, a set module 150, a lookup module 160, and a display module 170.

The word database 110 is used for storing words and corresponding translation data for the words.

The detect module 120 is used for detecting a position of a cursor after the cursor is moved by a user. The detect module 120 may first hook a program for controlling the cursor in a graphical interface operating system. Once the cursor is moved by the user, the graphical interface operating system executes the program for controlling the cursor, and thus, the detect module 120 can read current coordinates of the cursor by hooking the program for controlling the cursor, thereby obtaining the position of the cursor.

The graphical interface operating system executes at least one application, and is provided for displaying program execution results through graphical interfaces. Each application produces an individual independent window, and displays an execution result through the window.

The graphical interface operating system also provides a cursor control device (for example, a mouse, and so on) for a user to control the cursor movement, thereby enabling the user to control the cursor to move arbitrarily in a picture displayed on a screen. The cursor is displayed in the uppermost layer of the graphical interface. No matter where the cursor is moved, the cursor is displayed in the picture, i.e., when a window has already been displayed in a position where the cursor is moved to, the cursor is displayed above the original displayed window, that is to say, the user watches that the cursor overlaps the original window.

The detect module 120 future starts to detect the position of the cursor after receiving an execution signal. The execution signal is often produced upon being triggered by the user through, for example, pressing a start key for executing the software.

The retrieve module 130 is used for retrieving a word overlapping the cursor after the detect module 120 detects that the cursor is moved. The retrieve module 130 retrieves the word in the following manner. For example, first, a redraw function in an application for producing a window under the cursor is hooked, a signal for indicating that a coordinate point where the cursor is located is no longer valid is sent, so that a windows interface operating system instructs the application to redraw a coordinate point where the cursor is located, and then, the retrieve module 130 obtains the word overlapping the cursor by intercepting the data for the hooked redraw function, but the methods for retrieving a word proposed by the present invention are not limited here.

The retrieve module 130 can also expand a range of words to be retrieved. For example, the retrieve module 130 can set the range of words to be retrieved based on the coordinate point where the cursor is. The range set by the retrieve module 130 may include the coordinate point where the cursor is located, and a first word overlapping under the cursor and a second word arranged before or after the first word. For example, when the cursor overlaps a phase [symbol] if the cursor stays on a first word [symbol] the range of words retrieved by the retrieve module 130 is expanded gradually from the first word [symbol] and a word combination including the first word and the second word before or after the first word, for example, [symbol] and so on. After the above words are retrieved, they are compared in the word database 110 to see whether the above words have been recorded or not, and if yes, the word combination of the first word and the second word is defined as the retrieved word. In this way, the retrieve module 130 can retrieve a phrase formed by more than two words, for example, [symbol] rather than a single word

[symbol]

The retrieve module 130 can even retrieve a font size of a word while retrieving the word. When the application redraws the coordinate point where the cursor is located, besides the redrawn word, the retrieve module 130 can further retrieve the display parameters relevant to the word, for example, font size, font style, and so on.

The set module 150 is used for setting a scale parameter. The set module 150 may be provided for a user to set the scale parameter, or read a default value to implement the setting of the scale parameter.

The scale parameter corresponds to a display size, and the display size is used to define a dimension of the word retrieved by the retrieve module 130 when being displayed on the display module 170. Generally, the unit for the display size is “point (pt)”, but the present invention is not limited hereby. In addition, the scale parameter may be the display size, or is used to adjust a scale proportion of a dimension for displaying the word. That is, if the scale parameter is the display size, the dimension for displaying the word is the display size. If the scale parameter is the above scale proportion, the set module 150 calculates a corresponding display size by using the font size retrieved by the retrieve module 130 and the scale proportion. For example, when the font size is “12 points”, and the scale proportion is “magnifying for 0.5 times”, the word retrieved by the retrieve module 130 is magnified by “6 points” (“12 points”×“0.5”), i.e., the calculated display size is “18 points”.

The set module 150 may also set the display size to be smaller than the font size of the word through the scale parameter. Generally, such case occurs when the font size of the word exceeds a predefined value.

The lookup module 160 is used for looking up a corresponding translation data of the word overlapping the cursor and retrieved by the retrieve module 130 in the word database 110 after the retrieve module 130 retrieves the word.

The display module 170 is used for displaying the word retrieved by the retrieve module 130 based on the display size corresponding to the scale parameter set by the set module 150. The word retrieved by the retrieve module 130 may be displayed in a floating window (or called “pop-up window”) by the display module 170.

The display module 170 is also used for displaying the corresponding translation data for the retrieved word in a floating window. Generally, the display module 170 displays the floating window in any direction around the word, for example, upward, downward, leftward or rightward direction, i.e., a position closest to the word but not overlapping the word, but the present invention is not limited hereby. Moreover, when displaying the translation data for the retrieved word in the floating window, the display module 170 can display the translation data with a font size as the display size based on the display size.

The floating window for displaying the scaled word and the floating window for displaying the translation data for the word may be the same floating window, or different floating windows. Generally, two adjacent floating windows are used to display the scaled word and the translation data thereof.

In the case that the display module 170 displays the scaled word and the translation data of the word in two different windows, the display module 170 does not necessarily adopt a floating window with a traditional square outer frame for displaying the scaled word, but may adopt specific graphics that are not limited to circle and ellipse to display the scaled word, thereby enabling the scaled word to be displayed in the graphics.

In fact, the system of the present invention further includes a determination module 190 adapted to determine whether the font size of the word retrieved by the retrieve module 130 is adjustable or not. If the determination module 190 determines that the font size is adjustable, the display module 170 directly adjusts the font size of the retrieved word in the window produced by the application, so that the font size of the retrieved word is changed to meet the requirements of the display size. However, if the determination module determines that the font size of the word cannot be adjusted, the retrieved word is displayed by the display module 170 in the floating window as described above, and the retrieved word is displayed with the font size as the display size.

The process for the determination module 190 to determine whether the font size of the word is adjustable includes the following steps. First, a window which is the same as the window produced by the application is copied on a background of the windows interface operating system, then, it is attempted to set a different font size for the words in the copied window, and if the font size is set successfully, it indicates that the font size is adjustable, otherwise, the font size cannot be adjusted, but the present invention is not limited hereby.

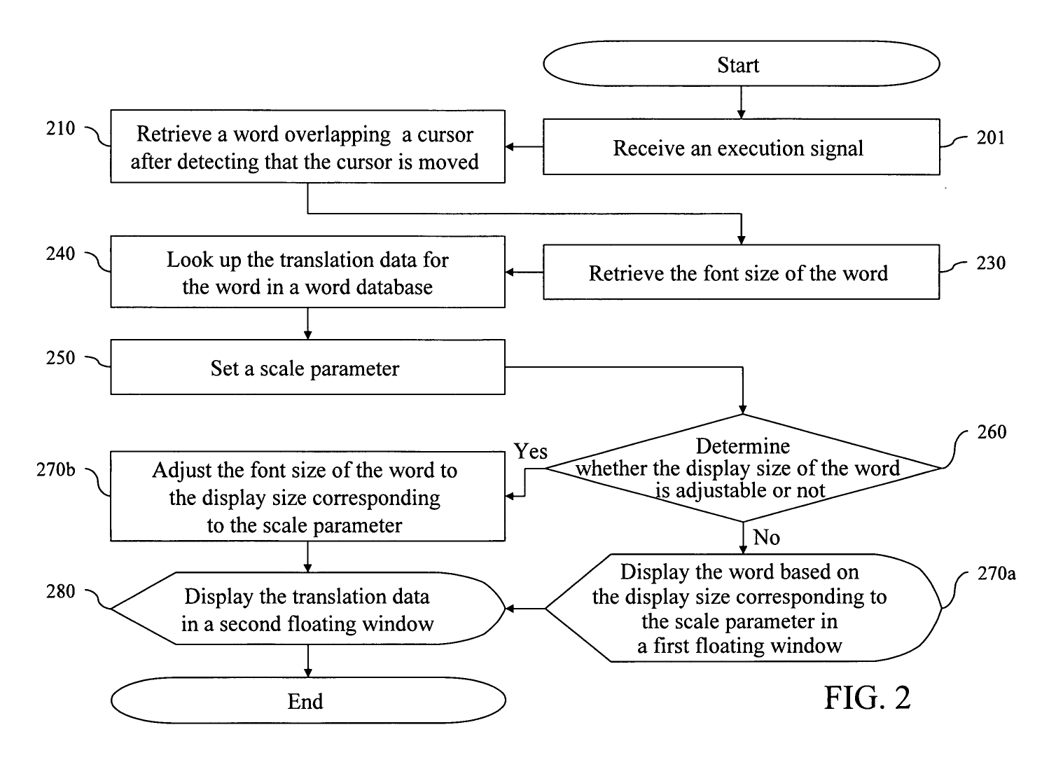

Then, the operating system and method of the present invention are explained with a first embodiment. FIG. 2 is a flow chart of a method for magnifiedly displaying a real-time translated word according to the present invention.

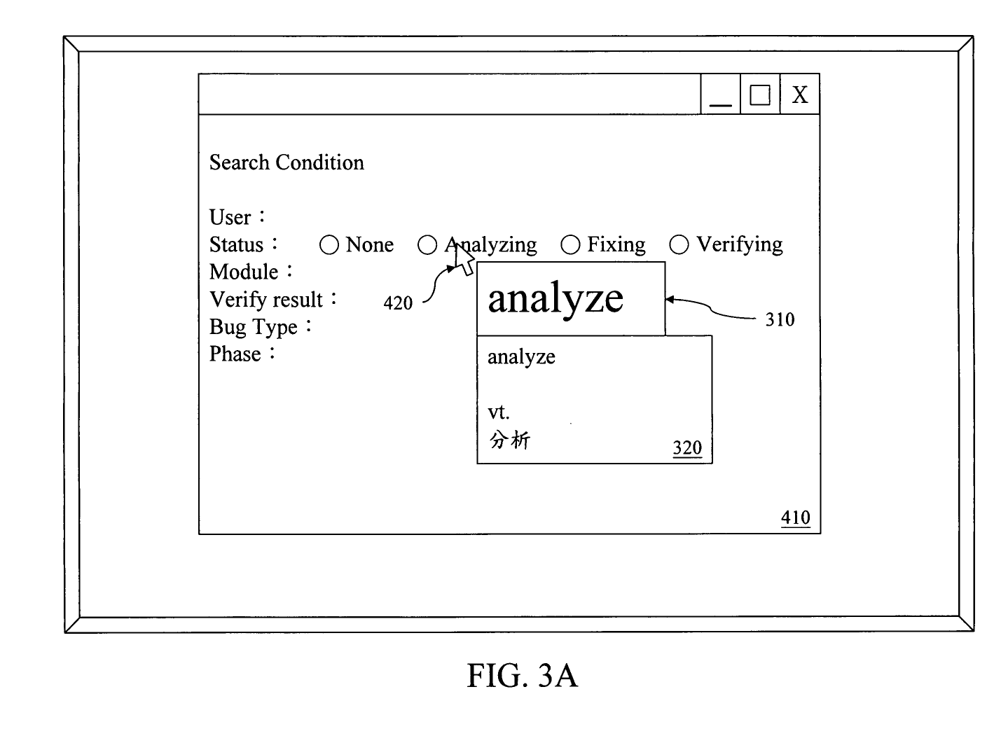

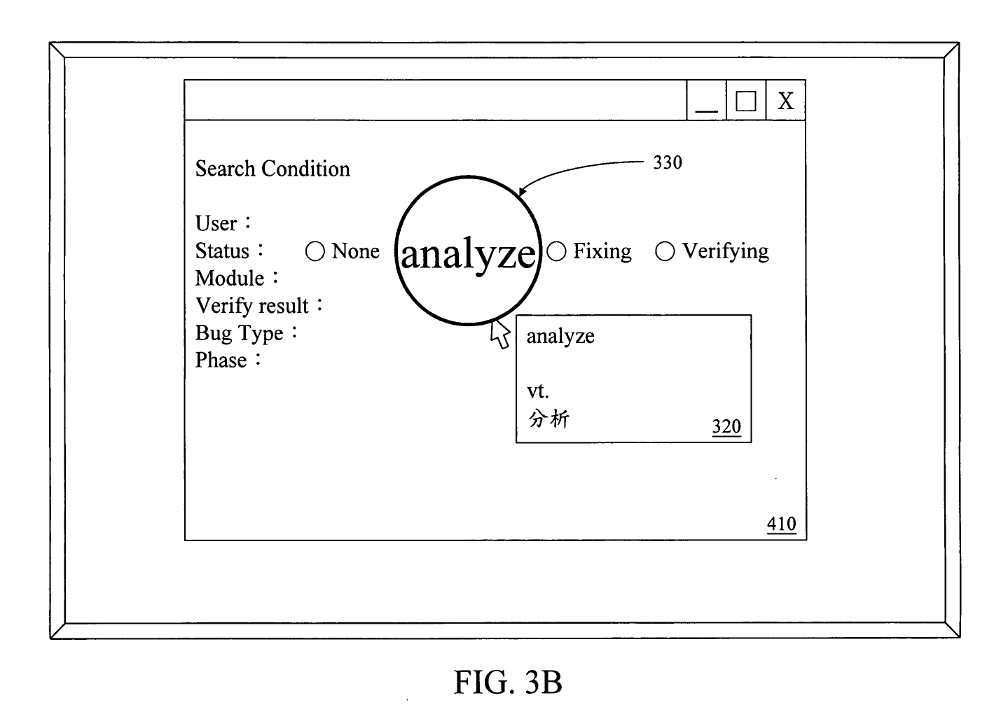

As shown in FIG. 3A, when the user moves a cursor 420 to a window 410 produced by a browser, the detect module 120 detects that the cursor is moved by the user due to the changing of coordinates (position) where the cursor is located, and further detects that the cursor 420 is moved to the window 410 through the coordinates where the cursor is located. Then, the retrieve module 130 retrieves a word “Analyzing” overlapping the cursor 420 in the window 410 (Step 210). In addition, the detect module 120 may detect the cursor 420 after receiving an execution signal (Step 201).

When retrieving the word “Analyzing”, the retrieve module 130 further retrieves a font size of the word “Analyzing” (Step 230) for being used later by the set module 150 if necessary. It is assumed in this embodiment that, the font size of the word “Analyzing” displayed in the window 410 is “16 points”.

After the retrieve module 130 retrieves the word (Step 210), the lookup module 160 looks up a translation data for the word “Analyzing” in the word database 110 (Step 240). In this embodiment, the translation data for the word “Analyzing” looked up by the lookup module 160 is

[symbol]

Then, the set module 150 sets a scale parameter (Step 250). It is assumed in this embodiment that the scale parameter is a scale proportion, and the set module 150 may read a predefined proportion value as the scale proportion, or read a value set by the user as the scale proportion. It is assumed in this embodiment that the scale proportion is a predefined value of “magnifying for 1 time”. Subsequently, the set module 150 calculates a display size for displaying the word “Analyzing” by the display module 170 is “32 points” through the scale proportion of “magnifying for 1 time” and the font size “16 points” of the word retrieved by the retrieve module 130.

After the set module 150 sets the scale parameter for the word (Step 250), the display module 170 displays the magnified word “Analyzing” with the display size of “32 points” in a first floating window 310 (Step 270a).

Before, after, or while the display module 170 displays the word based on the display size (Step 270a), the display module 170 further displays the translation data “ [symbol] [symbol] for the word “Analyzing” in a second floating window 320 (Step 280). The display module 170 may also display the translation data for the word “Analyzing” in the display size of “32 points” in the second floating window 320.

Moreover, in this embodiment, since the display module 170 displays the word in the first floating window, and displays the translation data for the word in the second floating window, the display module 170 may further represent the cursor 420 with a circular-shaped third floating window 330, and display the scaled word in a closed region enclosed by the circle, as shown in FIG. 3B.

The operating system and method of the present invention are further explained below with a second embodiment. FIG. 2 a flow chart of a method for magnifiedly displaying a real-time translated word according to the present invention.

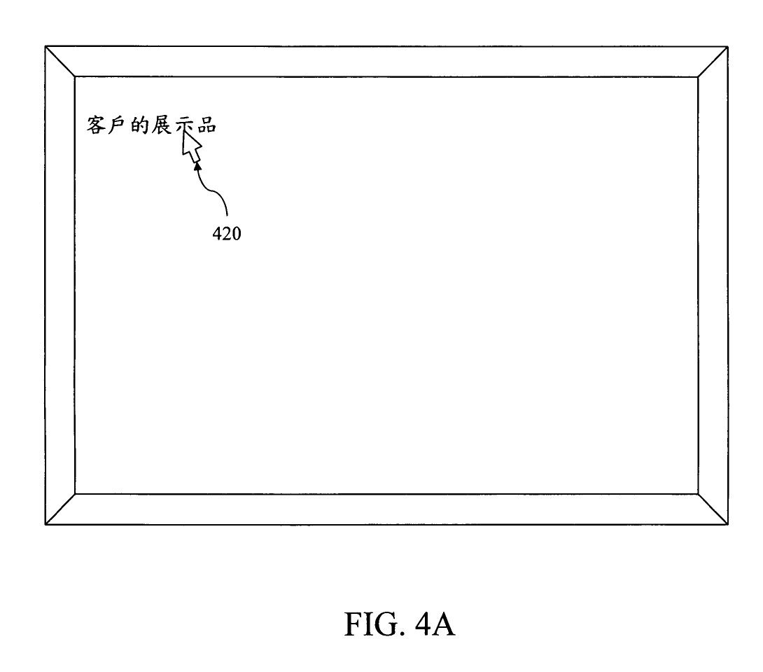

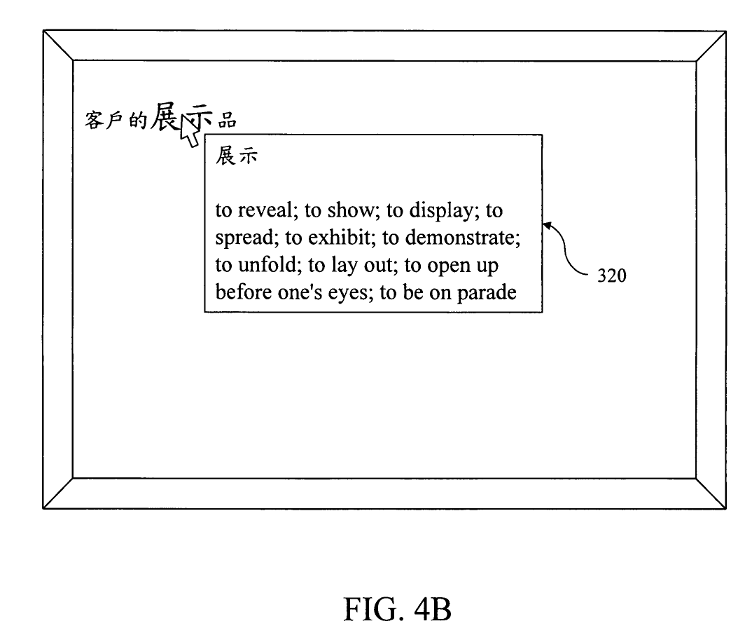

As shown in FIG. 4A, when the user moves the cursor 420 to a phase [symbol] [symbol] in a word editor, the detect module 120 detects that the cursor 420 is moved, and the retrieve module 130 sets a range of words to be retrieved based on the coordinates of the cursor and based on an arranging sequence of a first word [symbol] under the cursor and a second word [symbol] or [symbol] before or after the first word [symbol] and compares to see whether a word combination [symbol] of the first word and the second word is recorded in the word database 110 or not in the above manner. Since the word [symbol] is recorded in the word database 110, the word overlapping the cursor 420 retrieved by the retrieve module 130 from the window is [symbol] in this embodiment (Step 210).

Subsequently, the lookup module 160 looks up a translation data for the word [symbol] ” in the word database 110 (Step 240). It is assumed that the translation data for the word [symbol] looked up by the lookup module 160 is “to reveal; to show; to display; to spread; to exhibit; to demonstrate; to unfold; to lay out; to open up before one's eyes; to be on parade”.

After the lookup module 160 looks up the translation data for the word [symbol] (Step 240), the set module 150 sets a display size for the word [symbol] (Step 250). In this embodiment, it is assumed that the scale parameter is the display size, and the set module 150 reads a data “24 points” set by the user and sets it as the display size, and thus the display size is set as “24 points” by the set module 150.

After the set module 150 sets the display size for the word (Step 250), the determination module 290 determines that whether the font size of the word [symbol] in the word editor is adjustable or not (Step 260). Assuming that the word editor provides a function of adjusting a font size of a word, the determination module 290 determines that the font size of the word in the word editor is adjustable, and accordingly the display module 170 adjusts the font size of the word [symbol] in the word editor from “16 points” to the display size of “24 points”, as shown in FIG. 4B (Step 270b). However, if the window under the cursor is not a word editor, but an application whose font size cannot be adjusted, for example, a web browser, the determination module 290 determines that the font size of the word cannot be adjusted. Then, the display module 170 displays the word [symbol] with the display size of “24 points in the first floating window 310, as that in the first embodiment (step 270a).

After the display module 170 adjusts the font size of the word to the display size (Step 270a/Step 270b), the display module 170 displays the translation data for the word [symbol] in the second floating window 320.

To sum up, the difference between the present invention and the prior art is that, the present invention sets a display size for an retrieved word, and displays the retrieved word based on the display size and displays a looked up translation data thereof. With such technical means, the present invention can solve the problem in the prior art about an excessive large difference in the font size between a word in an existing file and a corresponding translation data thereof from the real-time translation, which tends to result in reading inconveniences for the user, and thus achieving a technical effect of magnifying the retrieved word.

Furthermore, the method for magnifiedly displaying a real-time translated word of the present invention can be implemented in hardware, software, or a combination of hardware and software, and can also be implemented in a centralized manner within a single computer system or implemented in a distributed manner in which different elements are distributed in several interconnected computer systems.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for magnifiedly displaying a real-time translated word, comprising:
retrieving a word overlapping a cursor after detecting that the cursor is moved;
looking up a translation data for the word in a word database;
setting a scale parameter;
displaying the word in a first floating window based on a display size corresponding to the scale parameter; and
displaying the translation data in a second floating window.

2. The method for magnifiedly displaying a real-time translated word according to claim 1, further comprising adjusting a font size of the word to the display size corresponding to the scale parameter when it is determined that the font size of the word is adjustable after setting the scale parameter.

3. The method for magnifiedly displaying a real-time translated word according to claim 2, wherein the step of displaying the word in the first floating window based on the display size is performed after it is determined that a font size of the word cannot be adjusted.

4. The method for magnifiedly displaying a real-time translated word according to claim 1, wherein the step of setting the scale parameter further comprises providing for a user to set the scale parameter, and calculating the display size based on a font size of the retrieved word and the scale parameter after retrieving the font size of the word.

5. The method for magnifiedly displaying a real-time translated word according to claim 1, wherein the step of displaying the translation data further comprises displaying the translation data based on the display size.

6. The method for magnifiedly displaying a real-time translated word according to claim 1, wherein the step of displaying the word in the first floating window based on the display size further comprises overlappingly displaying the first floating window on the word.

7. A system for magnifiedly displaying a real-time translated word, comprising:
a detect module, adapted to detect a position of a cursor after the cursor is moved;
a retrieve module, adapted to retrieve a word overlapping the cursor after the detect module has detected that the cursor is moved;
a set module, adapted to set a scale parameter, wherein, the scale parameter is corresponding to a display size;
a word database, adapted to store a translation data for the word;
a lookup module, adapted to look up the translation data in the word database; and
a display module, adapted to display the word in a first floating window based on the display size, and display the translation data in a second floating window.

8. The system for magnifiedly displaying a real-time translated word according to claim 7, further comprising: a determination module, adapted to determine whether a font size of the word is adjustable or not, wherein when the determination module determines that the font size of the word is adjustable, the display module adjusts the font size of the word to the display size, otherwise, the display module displays the word in the first floating window based on the display size.

9. The system for magnifiedly displaying a real-time translated word according to claim 7, wherein the set module is provided for a user to set the scale parameter, and calculates the display size based on a font size of the retrieved word and the scale parameter after the retrieve module retrieves the font size of the word.

10. The system for magnifiedly displaying a real-time translated word according to claim 7, wherein the display module is further adapted to display the translation data based on the display size.

11. The system for magnifiedly displaying a real-time translated word according to claim 7, wherein the display module is further adapted to overlappingly display the first floating window on the word.

12. The system for magnifiedly displaying a real-time translated word according to claim 7, wherein the display module displays the first floating window in a particular shape.

13. The system for magnifiedly displaying a real-time translated word according to claim 12, wherein the system takes the first floating window as the cursor.
